(19) United States
(12) Patent Application Publication
(10) Pub. No.: US 2009/0190660 A1
(43) Pub. Date: Jul. 30, 2009

(54) IMAGE ENCODING METHOD

(76) Inventors: Toshihiko KUSAKABE, Osaka (JP); Shinji KITAMURA, Kyoto (JP); Yasuharu TANAKA, Osaka (JP)

Correspondence Address: MCDERMOTT WILL & EMERY LLP, 600 13TH STREET, NW, WASHINGTON, DC, 20005-3096, US

(21) Appl. No.: 12/271,376

(22) Filed: Nov. 14, 2008

(30) Foreign Application Priority Data
Jan. 30, 2008 (JP) 2008-019467

(51) Int. Cl. H04N 7/32

(52) U.S. Cl. 375/240.13; 375/E07.146

(57) ABSTRACT

An image encoding method according to the present invention calculates first difference information of an encoding target block and second difference information of an adjacent block, calculates a difference between the first difference information and the second difference information, and uses an intra mode only for blocks where a residual image noise occurs by selecting the intra mode when the difference is larger than a predetermined threshold, and selecting an inter mode when the difference is smaller than the predetermined threshold.

### BACKGROUND OF THE INVENTION

1. Field of the Invention

The present invention relates to an image encoding method for encoding a moving image, and more particularly, to an image encoding method for adaptively switching between intra-frame encoding and inter-frame encoding and encoding a moving image.

2. Description of the Background Art

As a method for encoding moving image data, there are intra-frame encoding for encoding only information of a target frame, and inter-frame encoding for encoding a difference between a current frame and a previous frame and motion information. The intra-frame encoding removes spatial redundancy in a frame to compress a moving image, and is referred to as intra encoding. The inter-frame encoding removes temporal redundancy among two or more frames to compress a moving image, and is referred to as inter encoding.

In MPEG-2 and MPEG-4 AVC (Advanced Video Coding) of moving image encoding, it is possible to adaptively switch between intra-frame encoding and inter-frame encoding for each macroblock which is a process unit. In this case, it is necessary to determine which encoding is efficient to use. This determination is referred to as an intra/inter determination.

Various methods have been proposed for an intra/inter determination. As a representative determination method, there is a method disclosed in “Basic Technologies on International Image Coding Standards” cowritten by Fumitaka Ono and Hiroshi Watanabe, CORONA PUBLISHING CO., LTD., P223-224 (hereinafter, referred to a book written by Fumitaka Ono, et al). In the method, a dispersion of an input image in an encoding target block and a dispersion of an inter-frame difference image in the encoding target block after motion compensation are calculated, and values of these dispersion are compared with each other. FIG. 8 is a flow chart of a conventional intra/inter determination.

In an intra/inter determination method in FIG. 8, first, at a step S801, a dispersion of an input image in an encoding target block is calculated. Next, at a step S802, a dispersion of an inter-frame difference image in the encoding target block after motion compensation is calculated. Where the dispersion of the input image which is calculated at the step S801 is represented by y and the dispersion of the difference image which is calculated at the step S802 is represented by x, x and y are calculated by the following mathematical expression 1.

$$x = \frac{1}{256} {\sum }_{i = 1}^{16} {\sum }_{j = 1}^{16} {\vert {d}_{i , j} - D \vert}^{2} \\ {d}_{i , j} = {f}_{i , j} ( N ) - {f}_{i + MVx , j + MVy} ( N - 1 ) \\ D = \frac{1}{256} {\sum }_{i = 1}^{16} {\sum }_{j = 1}^{16} {d}_{i , j} \\ y = \frac{1}{256} {\sum }_{i = 1}^{16} {\sum }_{j = 1}^{16} {\vert {f}_{i , j} ( N ) - F \vert}^{2} \\ F = \frac{1}{256} {\sum }_{i = 1}^{16} {\sum }_{j = 1}^{16} {f}_{i , j} \qquad ( Mathematical Expression 1 )$$

At a step S803, magnitudes of x and y which are calculated by the mathematical expression 1 are compared with each other to make an intra/inter determination. When the dispersion x of the difference image is larger than the dispersion y of the input image, an intra mode is used as an encoding mode for the encoding target block (a step S804, MBType=INTRA). When the dispersion x of the difference image is smaller than the dispersion y of the input image, an inter mode is used as the encoding mode of the encoding target block (a step S805, MBType=INTER). It is noted that when a difference between x and y is small, the inter mode is used regardless of a result of magnitude comparison between x and y because an amount of generated codes is smaller when the inter mode is used as the encoding mode for the encoding target block. FIG. 9 is a view showing usage ranges of the intra mode and the inter mode based on a relation between x and y. When x>y, the intra mode (MBType=INTRA) is used. When x≦y, the inter mode (MBType=INTER) is used. It is noted that when x≦64, as the above case where the difference between x and y is small, the inter mode (MBType=INTER) is used regardless of a magnitude relation between x and y. Here, as an example of the case where the difference between x and y is small, the case of x≦64 is set, but the case is not limited thereto.

Further, Japanese Patent Laid-open Publication No. 2004-266720 discloses a method using an inter-frame difference absolute value sum after motion compensation for reducing an amount of calculation in an intra/inter determination. In this method, in addition to the above intra mode and inter mode, a skip mode in which a difference image is not encoded is selected depending on a value of a difference absolute value sum. FIG. 10 is a flow chart of an intra/inter determination in Japanese Patent Laid-open Publication No. 2004-266720.

In an intra/inter determination method in FIG. 10, first, at a step S1001, an inter-frame difference absolute value sum (CurrSAD) for an encoding target block after motion compensation is calculated. Next, at steps S1002 and S1003, the CurrSAD is compared with a predetermined first threshold Thr1 and a predetermined second threshold Thr2 to determine whether a difference therebetween is large, moderate, or small (it is noted that 0<Thr2<Thr1). When it is determined that the difference is large, namely, when it is determined that the CurrSAD is larger than the predetermined first threshold Thr1, the intra mode is used (a step S1006, MBType=INTRA). When the difference is moderate, namely, when the CurrSAD is equal to or smaller than the predetermined first threshold Thr1 and larger than the predetermined second threshold Thr2, the inter mode is used (a step S1005 MBType=INTER). When the difference is small, namely, when the CurrSAD is equal to or smaller than the predetermined second threshold Thr2, the skip mode is used (a step S1004, MBType=SKIP). FIG. 11 is a view showing usage ranges of the intra mode, the inter mode, and the skip mode based on a relation among the CurrSAD, the predetermined first threshold Thr1, and the predetermined second threshold Thr2. When the CurrSAD is larger than the first threshold Thr1, the intra mode (MBType=INTRA) is used. When the CurrSAD is equal to or smaller than the predetermined first threshold Thr1 and larger than the predetermined second threshold Thr2, the inter mode (MBType=INTER) is used. When the CurrSAD is equal to or smaller than the predetermined second threshold Thr2, the skip mode (MBType=SKIP) is used.

As described above, in the intra/inter determination method disclosed in Japanese Patent Laid-open Publication No. 2004-266720, only a difference absolute value sum is used for the intra/inter determination, thereby reducing an amount of calculation.

The above moving image encoding method disclosed in the book written by Fumitaka Ono, et al and the above moving image encoding method disclosed in Japanese Patent Laid-open Publication No. 2004-266720 are applicable to a network camera which requires a low bit rate. However, an amount of bits to be allocated to a difference image of each block is insufficient at a low bit rate. Thus, when the inter mode is selected for a region having motion, image degradation such as a residual image (hereinafter, referred to as a residual image noise) often occurs. FIG. 12 is a view showing a frame where a residual image noise occurs. In FIG. 12, in a frame 1201, a before-movement image 1202 indicated by a dash line is moved to a position of an after-movement image 1203 indicated by a solid line. Here, if a residual image noise occurs in a still region having no motion (a portion on a left side of the before-movement image 1202 in FIG. 12), the residual image noise is subjectively felt as large image degradation. Thus, it is necessary to prevent occurrence of a residual image noise in such a still region. For preventing occurrence of a residual image noise, for example, in the intra/inter determination in Japanese Patent Laid-open Publication No. 2004-266720, the predetermined first threshold Thr1 and the predetermined threshold Thr2 are set for easy selection of the intra mode. Thus, by using the intra mode for blocks where a residual image noise occurs, occurrence of a residual image noise can be prevented.

However, when the intra mode is easy to select, in the method disclosed in the book written by Fumitaka Ono, et al, the intra mode is selected for a block having a large dispersion due to movement, not due to a residual image noise, thereby increasing an amount of codes. FIG. 13 is a view showing a case where the intra mode is selected for encoding a block having a large dispersion In FIG. 13, a frame 1201 is divided into blocks of 8 columns and 5 rows. The 8 columns are referred to as A to H columns, and the 5 rows are referred to as first to fifth rows. Dotted D2 to D4, dotted E2 to E4, and dotted F2 to F4 are intra blocks for which the intra mode is used. The other portions are inter blocks for which the inter mode is used. Further, in the method disclosed in Japanese Patent Laid-open Publication No. 2004-266720, when a first threshold and a second threshold are set for easy selection of the intra mode in order to prevent occurrence of a residual image noise, the intra mode is actually selected for regions (E2 to E4 and F2 to F4) where image degradation is unlikely to be noticed because a moving object is present therein. This results in an increase in an amount of codes.

### SUMMARY OF THE INVENTION

Therefore, an object of the present invention is to provide a moving image encoding method which suppresses an increase in an amount of codes in encoding a moving image and prevents image degradation by, in an intra/inter determination in moving image encoding at a low bit rate, using an intra mode only for blocks where a residual image noise occurs.

In order to attain the object mentioned above, a first image encoding method according to the present invention is an image encoding method, for adaptively selecting either an intra mode which is intra-frame encoding or an inter mode which is inter- frame encoding and for sequentially encoding a predetermined block image, comprising: an encoding target block difference information calculation step of calculating first difference information based on an encoding target block and a reference image; an adjacent block difference information calculation step of calculating at least one or more pieces of second difference information based on the reference image and at least one or more adjacent blocks among eight adjacent blocks adjacent to the encoding target block; an intra/inter determination step of calculating at least one or more differences between the first difference information and the second difference information, and comparing said at least one or more differences with a predetermined threshold; an intra mode usage step of using the intra mode as an encoding mode for the encoding target block when any of said at least one or more differences is larger than the predetermined threshold, and an inter mode usage step of using the inter mode as the encoding mode for the encoding target block when all of said at least one or more differences are smaller than the predetermined threshold.

Preferably, the first image encoding method according to the present invention further comprises a difference information storing step of storing the first difference information in a memory, and at the adjacent block difference information calculation step, when any one of said eight adjacent blocks becomes an encoding target block, the first difference information stored in the memory is used as the second difference information.

Preferably, the first difference information is a difference absolute value sum between the encoding target block and the reference image, and the second difference information is difference absolute value sums between said at least one or more adjacent blocks and the reference image.

Preferably, said at least one or more adjacent blocks include a left adjacent block adjacent to the encoding target block on a left side thereof and an upper adjacent block adjacent to the encoding target block on an upper side thereof.

In order to attain the object mentioned above, a second image encoding method according to the present invention is an image encoding method, for adaptively selecting either an intra mode which is intra-frame encoding or an inter mode which is inter-frame encoding and for sequentially encoding a predetermined block image, comprising: an encoding target block difference information calculation step of calculating first difference information based on an encoding target block and a reference image; an adjacent block difference information calculation step of calculating at least one or more pieces of second difference information based on the reference image and at least one or more adjacent blocks among eight adjacent blocks adjacent to the encoding target block; an intra/inter determination step of calculating at least one or more differences between the first difference information and the second difference information, and comparing said at least one or more differences with a predetermined threshold; an activity information determination step of, when all of said at least one or more differences are smaller than the predetermined threshold, calculating activity information indicative of a complexity of the encoding target block, and comparing the activity information with the first difference information; an intra mode usage step of using the intra mode as an encoding mode for the encoding target block when any of said at least one or more differences is larger than the predetermined threshold or when all of said at least one or more differences are smaller than the predetermined threshold and the activity information is smaller than the first difference information; an inter mode usage step of using the inter mode as the encoding mode for the encoding target block when all of said at least one or more differences are smaller than the predetermined threshold and the activity information is larger than the first difference information.

Preferably, the activity information is calculated based on a dispersion of the encoding target block, and the first difference information is calculated based on a dispersion of a difference image between the encoding target block and the reference image.

In order to attain the object mentioned above, a third image encoding method according to the present invention is an image encoding method, for adaptively selecting either an intra mode which is intra-frame encoding or an inter mode which is inter-frame encoding and for sequentially encoding a predetermined block image, comprising: an encoding target block motion vector calculation step of calculating a motion vector of the encoding target block; an encoding target block difference information calculation step of calculating first difference information based on an encoding target block and a reference image; an adjacent block difference information calculation step of calculating at least one or more pieces of second difference information based on the reference image and at least one or more adjacent blocks among eight adjacent blocks adjacent to the encoding target block; an intra/inter determination step of calculating at least one or more differences between the first difference information and the second difference information, and comparing said at least one or more differences with a predetermined threshold, and comparing the motion vector with a predetermined motion vector threshold; an intra mode usage step of using the intra mode as an encoding mode for the encoding target block when a residual image noise occurrence condition is satisfied that any of said at least one or more differences is larger than the predetermined threshold, that a magnitude of the motion vector is larger than the predetermined motion vector threshold, and that a direction of the motion vector is a direction from the adjacent block corresponding to said any of said at least one or more differences toward the encoding target block; an inter mode usage step of using the inter mode as the encoding mode for the encoding target block in a case other than a case where the residual image noise occurrence condition is satisfied.

Preferably, the third image encoding method according to the present invention further comprises a difference information storing step of storing the first difference information in a memory, and at the adjacent block difference information calculation step, when any one of said eight adjacent blocks becomes an encoding target block, the first difference information stored in the memory is used as the second difference information.

Preferably, the predetermined threshold is adaptively changed based on a magnitude of a quantization parameter.

Preferably, the predetermined threshold is adaptively changed based on a magnitude of the motion vector.

In order to attain the object mentioned above, an image encoding apparatus according to the present invention is an image encoding apparatus, for adaptively selecting either an intra mode which is intra-frame encoding or an inter mode which is inter-frame encoding and for sequentially encoding a predetermined block image, comprising: an encoding target block difference information calculation section for calculating first difference information based on an encoding target block and a reference image; an adjacent block difference information calculation section for calculating at least one or more pieces of second difference information based on the reference image and at least one or more adjacent blocks among eight adjacent blocks adjacent to the encoding target block; an intra/inter determination section for calculating at least one or more differences between the first difference information and the second difference information, and comparing said at least one or more differences with a predetermined threshold; an intra mode usage section for using the intra mode as an encoding mode for the encoding target block when any of said at least one or more differences is larger than the predetermined threshold; and an inter mode usage section for using the inter mode as the encoding mode for the encoding target block when all of said at least one or more differences are smaller than the predetermined threshold.

Preferably, the image encoding apparatus according to the present invention further comprises a difference information storing section for storing the first difference information in a memory, and the adjacent block difference information calculation section uses the first difference information stored in the memory as the second difference information when any one of said eight adjacent blocks becomes an encoding target block.

Preferably, the first difference information is a difference absolute value sum between the encoding target block and the reference image, and the second difference information is difference absolute value sums between said at least one or more adjacent blocks and the reference image.

Preferably, said at least one or more adjacent blocks include a left adjacent block adjacent to the encoding target block on a left side thereof and an upper adjacent block adjacent to the encoding target block on an upper side thereof.

Preferably, the predetermined threshold is adaptively changed based on a magnitude of a quantization parameter.

In order to attain the object mentioned above, an integrated circuit for use in an image encoding apparatus according to the present invention is an integrated circuit for use in an image encoding apparatus, for adaptively selecting either an intra mode which is intra-frame encoding and an inter mode which is inter-frame encoding and for sequentially encoding a predetermined block image, functioning as: an encoding target block difference information calculation section of calculating first difference information based on an encoding target block and a reference image; an adjacent block difference information calculation section of calculating at least one or more pieces of second difference information based on the reference image and at least one or more adjacent blocks among eight adjacent blocks adjacent to the encoding target block; an intra/inter determination section of calculating at least one or more differences between the first difference information and the second difference information, and comparing said at least one or more differences with a predetermined threshold; an intra mode usage section of using the intra mode as an encoding mode for the encoding target block when any of said at least one or more differences is larger than the predetermined threshold; and an inter mode usage section of using the inter mode as the encoding mode for the encoding target block when all of said at least one or more differences are smaller than the predetermined threshold.

In order to attain the object mentioned above, a photographing system according to the present invention is a photographing system, for using an image encoding method in which either an intra mode which is intra-frame encoding and an inter mode which is inter-frame encoding is adaptively selected and a predetermined block image is sequentially encoded, comprising: an optical system for causing incident image light to form an image; a sensor for converting the image light which is caused to form the image into an image signal; and an image processing circuit for imaging-processing the image signal. The image processing circuit executes the above image encoding method according to the present invention.

As described above, according to the present invention, in an intra/inter determination in moving image encoding at a low bit rate, an intra mode is used only for blocks where a residual image noise occurs, thereby realizing a moving image encoding method which prevents image degradation while suppressing an increase in an amount of codes in encoding a moving image.

An image encoding method according to the present invention can prevent a residual image noise from occurring while minimizing an increase in an amount of codes in encoding an moving image by using an intra mode only for blocks where a residual image noise occurs. Thus, the image encoding method is useful for an image encoding apparatus for a network camera and a monitoring camera which require high image quality at a low bit rate, and the like.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a flow chart of an intra/inter determination according to a first embodiment of the present invention;

FIG. 2 is a view showing positions of an encoding target block and adjacent blocks according to the first embodiment of the present invention;

FIG. 3 is a view showing selection of an encoding mode for blocks by the intra/inter determination according to the first embodiment of the present invention;

FIG. 4 is a flow chart of an intra/inter determination according to a second embodiment of the present invention;

FIG. 5 is a view showing positions of an encoding target block and adjacent blocks according to the second embodiment of the present invention;

FIG. 6 is a view showing a configuration of an image encoding apparatus 600 according to a third embodiment of the present invention;

FIG. 7 is a view showing a configuration of a photographing system 700 according to a fourth embodiment of the present invention;

FIG. 8 is a flow chart of a conventional intra/inter determination;

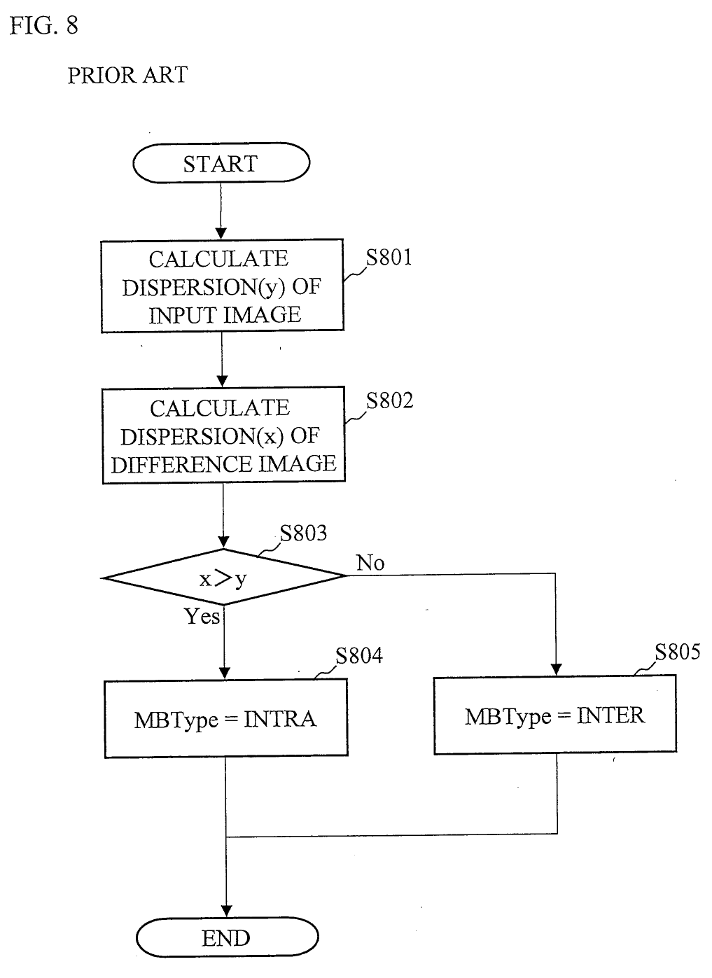

FIG. 9 is a view showing usage ranges of an intra mode and an inter mode;

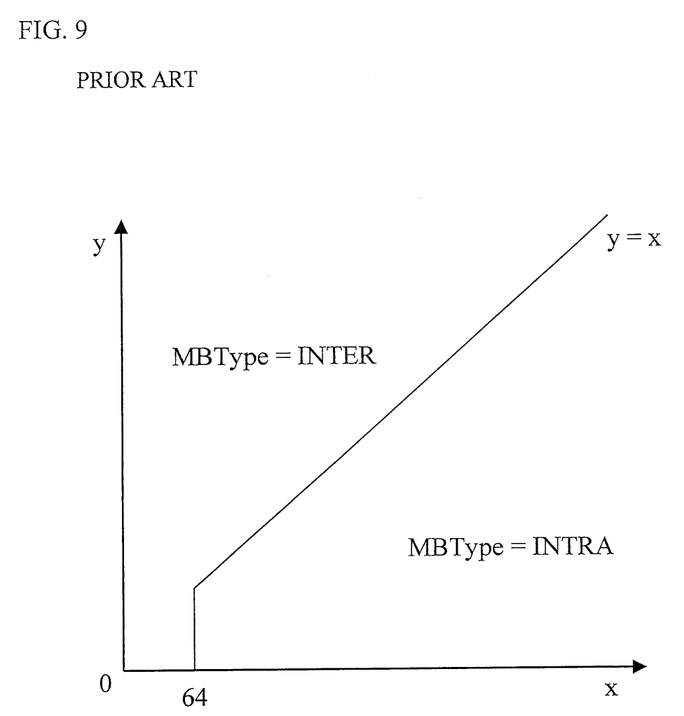

FIG. 10 is a flow chart of a conventional intra/inter determination;

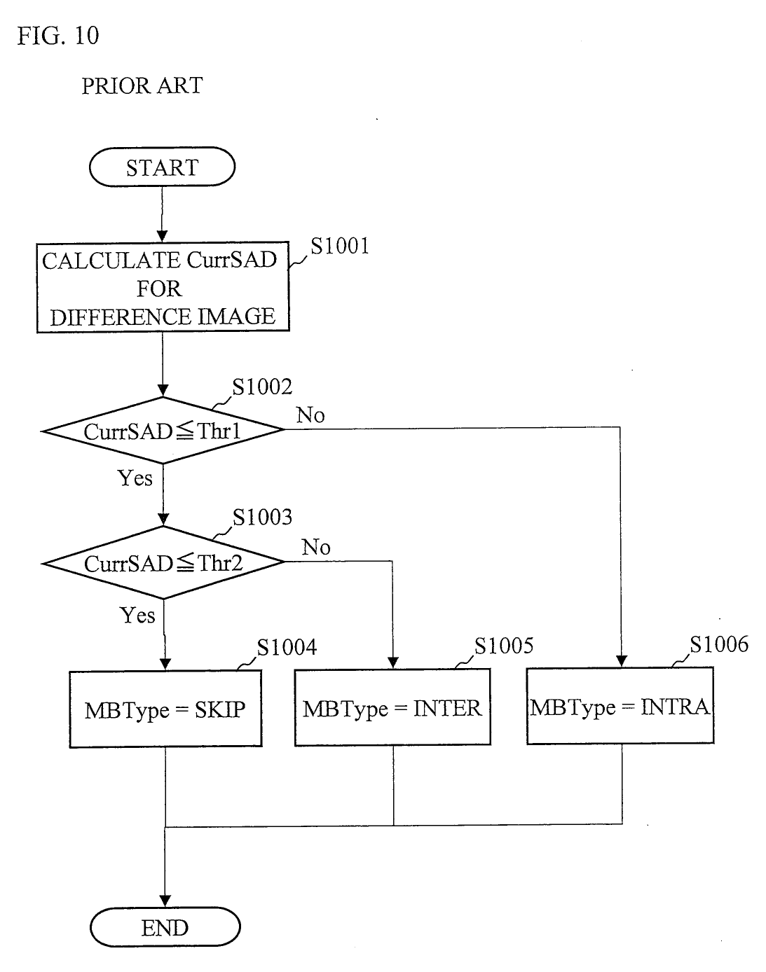

FIG. 11 is a view showing usage ranges of an intra mode, an inter mode, and a skip mode;

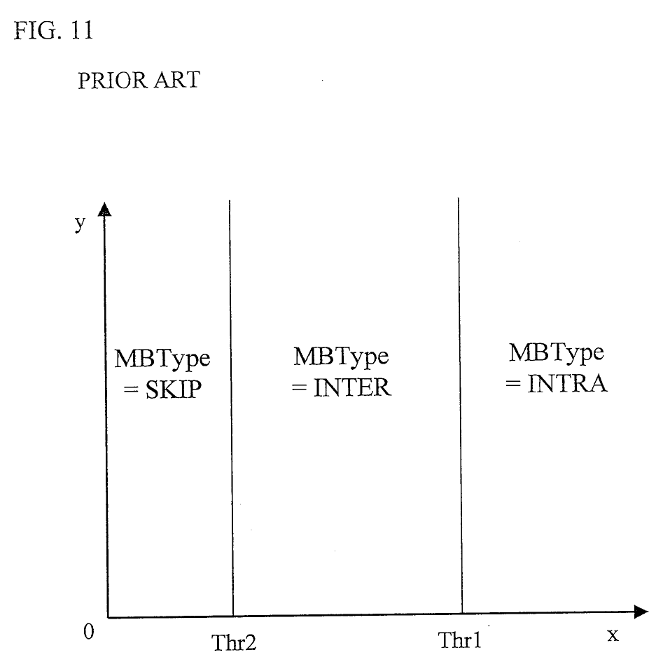

FIG. 12 is a view showing a frame where a residual image noise occurs; and

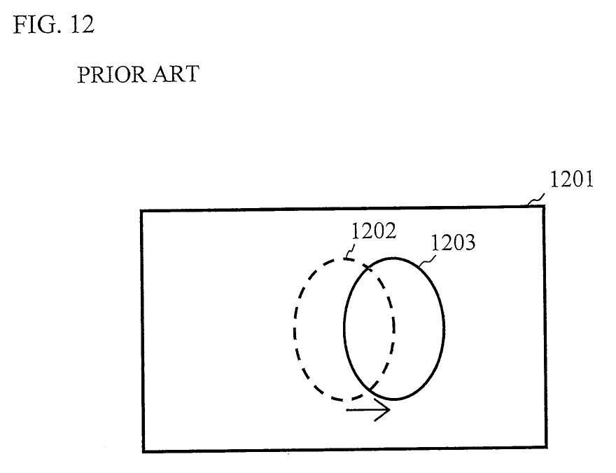

FIG. 13 is a view showing a case where the intra mode is selected for encoding a block having a large dispersion.

### DESCRIPTION OF THE PREFERRED EMBODIMENTS

The following will describe embodiments of the present invention with reference to the drawings.

### First Embodiment

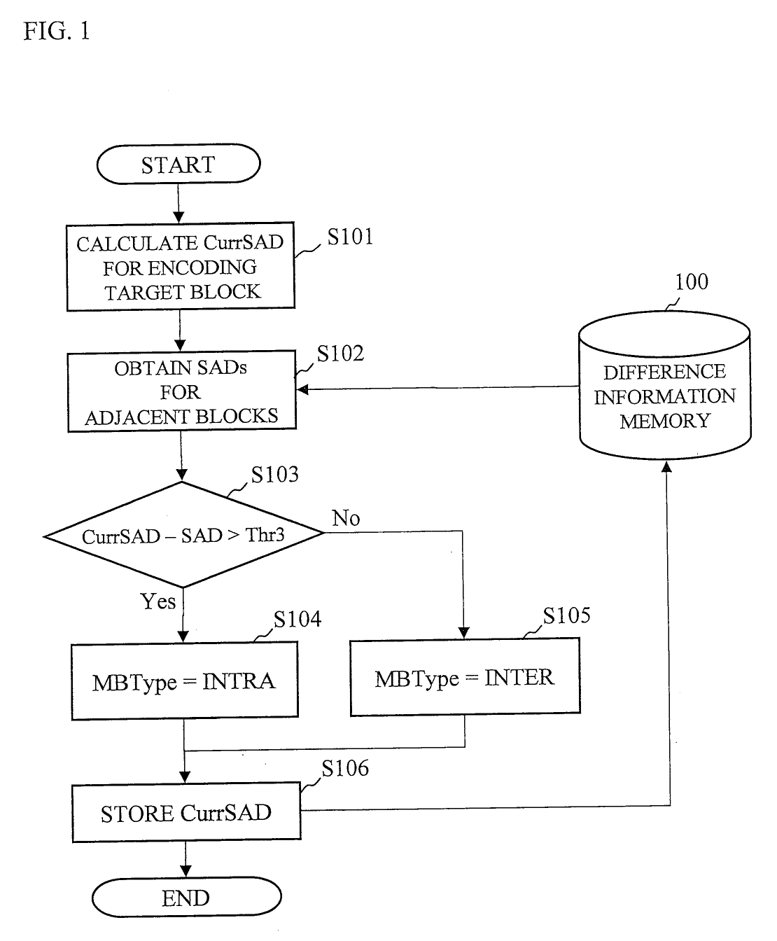

FIG. 1 is a flow chart of an intra/inter determination according to a first embodiment of the present invention. An intra/inter determination method according to the first embodiment of the present invention includes an encoding target block difference absolute value sum calculation step S101, an adjacent block difference absolute value sum obtaining step S102, an intra/inter determination step S103, an intra mode usage step S104, an inter mode usage step S105, and a difference absolute value sum storing step S106.

At the encoding target block difference absolute value sum calculation step S101, a difference absolute value sum (CurrSAD) of a difference image between a prediction image obtained by motion compensation and an encoding target block is calculated.

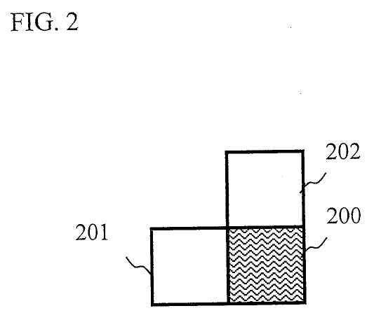

At the adjacent block difference absolute value sum obtaining step S102, difference absolute value sums (SADs) for adjacent blocks adjacent to the encoding target block are obtained from a difference information memory 100. At this time, the adjacent blocks are a block adjacent to the encoding target block on an upper side thereof and a block adjacent to the encoding target block on a left side thereof. FIG. 2 is a view showing positions of the encoding target block and the adjacent blocks. A left adjacent block 201 is adjacent to an encoding target block 200 on a left side thereof, and an upper adjacent block 202 is adjacent to the encoding target block 200 on an upper side thereof. An SAD for the left adjacent block 201 is represented by S1, and an SAD for the upper adjacent block 202 is represented by S2.

At the intra/inter determination step S103, difference absolute values between the difference absolute value sum (CurrSAD) for the encoding target block and the difference absolute value sums (SADs) for the adjacent blocks are compared with a predetermined threshold. When a residual image noise is subjectively noticeable, the residual image noise occurs in a region where an image is still. For the region where an image is still, a difference absolute value sum is small because a prediction error between the image and a reference image is small. On the other had, for a block where a residual image noise occurs, a difference absolute value sum is large because a prediction error between the image and a reference image is large. Thus, the difference absolute value sum (CurrSAD) for the encoding target block and the difference absolute value sums (SADs) for the adjacent blocks are compared with each other, thereby determining a block where a residual image noise occurs. For example, as shown in the following mathematical expression 2, difference absolute values between the CurrSAD and S1 and S2 are compared with a predetermined threshold Thr3:

(CurrSAD−S1)>Thr3 or (CurrSAD−S2)>Thr3. (Mathematical Expression 2)

At the intra mode usage step S104, when any of the difference absolute values is larger than the predetermined threshold, the intra mode is used as the encoding mode for the encoding target block (MBType=INTRA). More specifically, at the intra mode usage step S104, when a condition of the mathematical expression 2 shown at the intra/inter determination step S103 is satisfied, the intra mode is used as the encoding mode for the encoding target block.

At the inter mode usage step S105, when all of the difference absolute values are smaller than the predetermined threshold, the inter mode is used as the encoding mode for the encoding target block (MBType=INTER). More specifically, at the inter mode usage step S105, when the condition of the mathematical expression 2 shown at the intra/inter determination step S103 is not satisfied, the inter mode is used as the encoding mode for the encoding target block.

At the difference absolute value sum storing step S106, the difference absolute value sum (CurrSAD) for the encoding target block is stored in the difference information memory 100. This is because in an intra/inter determination for a block which is to be an encoding target block later, the difference absolute value sum (CurrSAD) for the encoding target block is used as a difference absolute value sum (SAD) for an adjacent block adjacent to the block which is to be an encoding target block later.

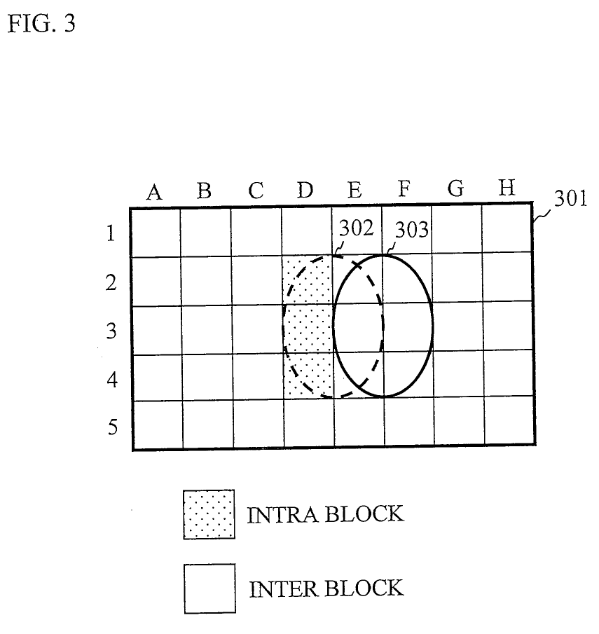

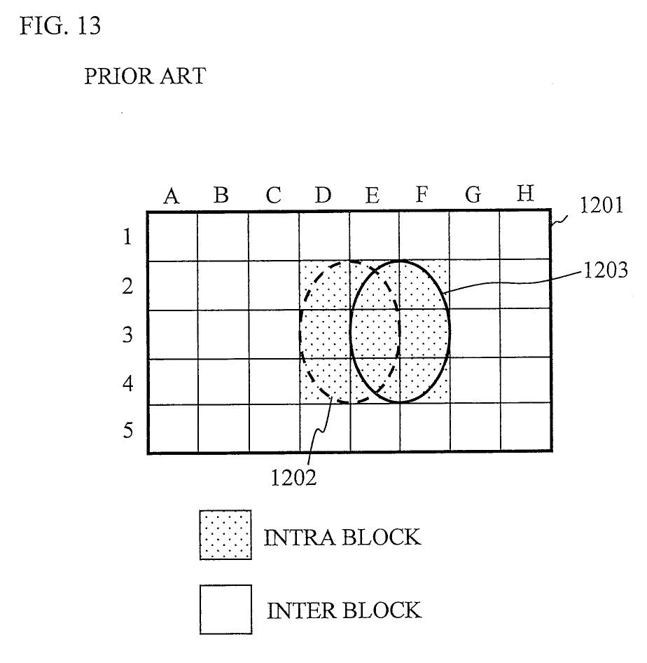

As described above, by making the intra/inter determination, the intra mode can be used only for blocks where a residual image noise occurs. FIG. 3 is a view showing selection of an encoding mode for blocks by the intra/inter determination according to the first embodiment of the present invention. As shown in FIG. 3, in a frame 301, a before-movement image 302 indicated by a dash line is moved to a position of an after-movement image 303. The frame 301 is divided into blocks of 8 columns and 5 rows. The 8 columns are referred to as A to H columns, and the 5 rows are referred to as first to fifth rows. Dotted D2 to D4 are intra blocks for which the intra mode is used, and the other portions are inter blocks for which the inter mode is used. In the intra/inter determination according to the first embodiment of the present invention, unlike the conventional intra/inter determination shown in FIG. 13, the intra mode is not used for but the inter mode is used for a region (E2-E4, and F2-F4) where image degradation due to a residual image noise is actually unnoticeable because a moving object is present therein.

As described above, according to the intra/inter determination according to the first embodiment of the present invention, in an intra/inter determination in moving image encoding at a low bit rate, the intra mode is used only for blocks where a residual image noise occurs, thereby realizing a moving image encoding method which prevents image degradation while suppressing an increase in an amount of codes in encoding a moving image.

In the present embodiment, as a method of calculating a difference absolute value sum (SAD) for an adjacent block adjacent to the encoding target block, an SAD is obtained from the difference information memory 100 at the adjacent block difference absolute value sum obtaining step S102, but the present invention is not limited thereto. For example, the difference absolute value sum storing step S106 and the difference information memory 100 may not be included, and at the adjacent block difference absolute value sum obtaining step S102, similarly as at the encoding target block difference absolute value sum calculation step S101, a difference absolute value sum (SAD) may be calculated based on a reference image and an adjacent block.

The present embodiment has described the case of using the left side adjacent block and the upper side adjacent block as adjacent blocks adjacent to the encoding target block, but the present invention is not limited thereto. For example, a block adjacent to the encoding target block on an upper left side thereof and a block adjacent to the encoding target block on an upper right side thereof may be the adjacent blocks adjacent to the encoding target block.

At the intra/inter determination step S103 shown in FIG. 1, when it is determined that the difference absolute value is smaller than the predetermined threshold, the difference absolute value sum (CurrSAD) for the encoding target block may further be compared with activity information indicative of a complexity of the input image. Specifically, the activity information is calculated from a dispersion of the input image, and the like. When the activity information is smaller than the CurrSAD, it is considered that the encoding target block is simple and efficiency of encoding at the intra mode is high. Thus, the intra mode is used for the encoding target block. On the other hand, when the activity information is larger than the CurrSAD, it is considered that encoding target is complicated and efficiency of encoding at the inter mode is high. Thus, the inter mode is used for encoding target.

### Second Embodiment

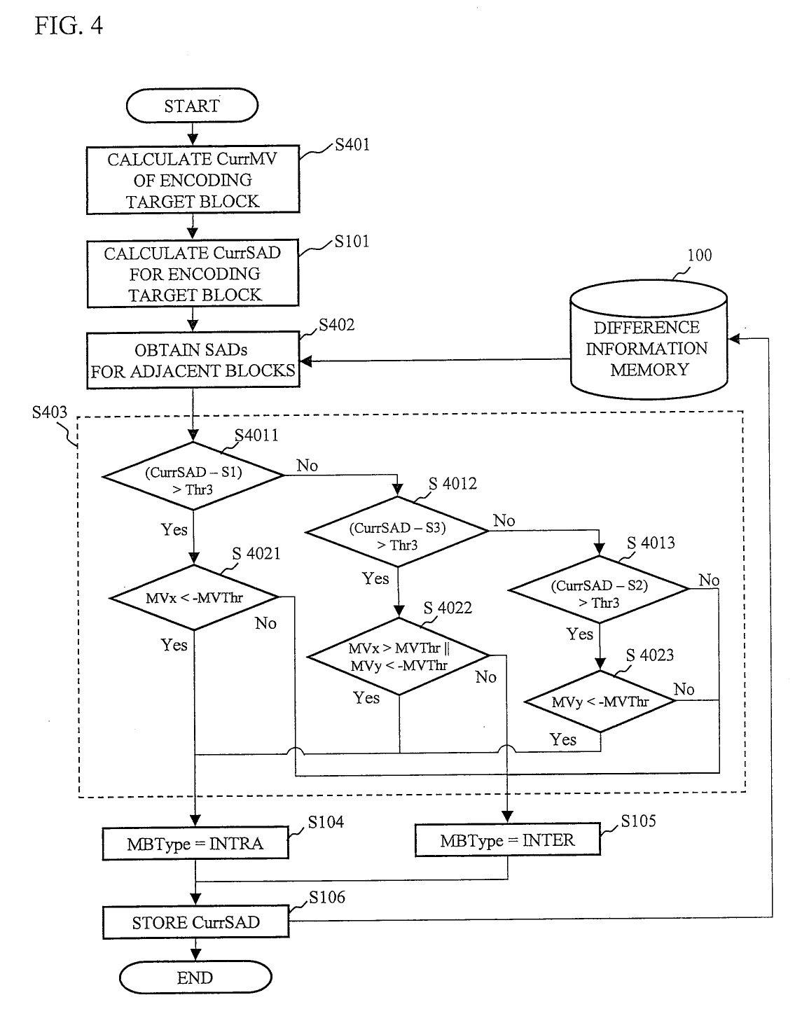

FIG. 4 is a flow chart of an intra/inter determination according to a second embodiment of the present invention. An intra/inter determination method according to the second embodiment of the present invention includes an encoding target block motion vector calculation step S401, an encoding target block difference absolute value sum calculation step S101, an adjacent block difference absolute value sum obtaining step S402, an intra/inter determination step S403, an intra mode usage step S104, an inter mode usage step S105, and a difference absolute value sum storing step S106. The intra/inter determination step S403 includes first to third difference absolute value sum comparison steps S4011 to S4013, and first to third motion vector comparison steps S4021 to S4023. In FIG. 4, the same steps as those shown in FIG. 1 are designated by the same reference characters, and description thereof will be omitted.

At the encoding target block motion vector calculation step S401, a motion vector (CurrMV) of an encoding target block is calculated by motion search based on a reference image. As a motion search method, for example, a commonly-used block matching method may be used.

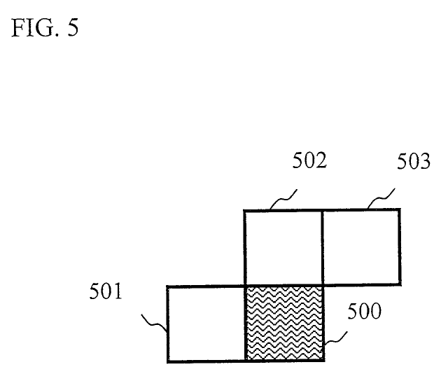

At the adjacent block difference absolute value sum obtaining step S402, difference absolute value sums (SAD) for adjacent blocks is obtained from a difference information memory 100. At this time, in addition to the block adjacent to the encoding target block on the left side thereof and the block adjacent to the encoding target block on the upper side thereof as shown in the first embodiment of the present invention, the adjacent blocks further include a block adjacent to the encoding target block on an upper right side thereof. FIG. 5 is a view showing positions of the encoding target block and the adjacent blocks. A left adjacent block 501 is adjacent to an encoding target block 500 on a left side thereof, an upper adjacent block 502 on an upper side thereof, and an upper right adjacent block 503 on an upper right side thereof. A difference absolute value sum (SAD) for the left adjacent block 501 is represented by S1, a difference absolute value sum (SAD) for the upper adjacent block 502 is represented by S2, and a difference absolute value sum (SAD) for the upper right adjacent block 503 is represented by S3.

At the intra/inter determination step S403, difference absolute values between a difference absolute value sum (CurrSAD) for the encoding target block and the difference absolute value sums (SADs) for the adjacent blocks are compared with a predetermined threshold. Further, at the intra/inter determination step S403, the motion vector (CurrMV) of the encoding target block is compared with a predetermined motion vector threshold. As described above, the intra/inter determination step S403 includes the first to third difference absolute value sum comparison steps S4011 to S4013 and the first to third motion vector comparison steps S4021 to S4023, and the following will describe a detail thereof.

At the first difference absolute value sum comparison step S4011, a difference absolute value between the difference absolute value sum (CurrSAD) for the encoding target block which is calculated at the encoding target block difference absolute value sum calculation step S101 and the difference absolute value sum S1 for the left adjacent block 501 which is obtained at the adjacent block difference absolute value sum obtaining step S402 is calculated, and compared with a predetermined threshold Thr3. When the difference absolute value is larger than the predetermined threshold Thr3 ((CurrSAD−S1)>Thr3), the intra/inter determination step S403 proceeds to the first motion vector comparison step S4021. In a case other than the above case, the intra/inter determination step S403 proceeds to the second difference absolute value sum comparison step S4012.

At the first motion vector comparison step S4021, a horizontal component MVx of the motion vector (CurrMV) of the encoding target block is compared with a predetermined motion vector threshold (−MVThr) to determine a movement direction of an object with respect to the encoding target block. When the MVx is smaller than the −MVThr (MVx<−MVThr), the object is considered to move rightward. By determining that (CurrSAD−S1)>Thr3 at the first difference absolute value sum comparison step S4011, it is seen that the CurrSAD for the encoding target block has increased from the difference absolute value sum S1 for the left adjacent block. Thus, when the MVx is smaller than the −MVThr (MVx<−MVThr), it is determined that a residual image noise occurs on a left side of the object when the object moves rightward. In this case, the intra/inter determination step S403 proceeds to the intra mode usage step S104, and the intra mode is used as the encoding mode for the encoding target block (MBType=INTRA).

On the other hand, when the MVx is equal to or larger than the −MVThr, because the CurrSAD for the encoding target block has increased from the difference absolute value sum S1 for the left adjacent block and a direction from the left adjacent block 501 toward the encoding target block 500 is different from the movement direction of the object, it is determined that a residual image noise has not occurred. In this case, the intra/inter determination step S403 proceeds to the inter mode usage step S105, and the inter mode is used as the encoding mode for the encoding target block (MBType=INTER).

At the second difference absolute value sum comparison step S4012, a difference absolute value between the difference absolute value sum (CurrSAD) for the encoding target block which is calculated at the encoding target block difference absolute value sum calculation step S101 and the difference absolute value sum S3 for the upper right adjacent block 503 which is obtained at the adjacent block difference absolute value sum obtaining step S402 is calculated, and compared with the predetermined threshold Thr3. When the difference absolute value is larger than the predetermined threshold Thr3 ((CurrSAD−S3)>Thr3), the intra/inter determination step S403 proceeds to the second motion vector comparison step S4022. In a case other than the above case, the intra/inter determination step S403 proceeds to the third difference absolute value sum comparison step S4013.

At the second motion vector comparison step S4022, the horizontal component MVx of the motion vector (CurrMV) of the encoding target block is compared with the predetermined motion vector threshold (MVThr) to determine the movement direction of the object with respect to the encoding target block. When the MVx is larger than the MVThr (MVx>MVThr), the object is considered to move leftward. By determining that (CurrSAD−S3)>Thr3 at the second difference absolute value sum comparison step S4012, it is seen that the CurrSAD for the encoding target block has increased from the difference absolute value sum S3 for the upper right adjacent block. Thus, when the MVx is larger than the MVThr (MVx>MVThr), it is determined that a residual image noise has occurred on a right side of the object when the object moves leftward. In this case, the intra/inter determination step S403 proceeds to the intra mode usage step S104, and the intra mode is used as the encoding mode for the encoding target block (MBType=INTRA)

At the second motion vector comparison step S4022, further, a vertical component MVy of the motion vector (CurrMV) of the encoding target block is compared with the predetermined motion vector threshold (−MVThr) to determine the movement direction of the object with respect to the encoding target block. When the MVy is smaller than the −MVThr (MVy<−MVThr), the object is considered to move downward. By determining that (CurrSAD−S3)>Thr3 at the second difference absolute value sum comparison step S4012, it is seen that the CurrSAD for the encoding target block has increased from the difference absolute value sum S3 for the upper right adjacent block. Thus, when the MVy is smaller than the −MVThr (MVy<−MVThr), it is determined that a residual image noise occurs on an upper side of the object when the object moves downward. In this case, the intra/inter determination step S403 proceeds to the intra mode usage step S104, and the intra mode is used as the encoding mode for the encoding target block (MBType=INTRA).

On the other hand, when the MVx is equal to or smaller than the MVThr, because the CurrSAD for the encoding target block has increased from the difference absolute value sum S3 for the upper right adjacent block and, regarding the horizontal direction, a direction from the upper right adjacent block 503 toward the encoding target block 500 is different from the movement direction of the object, it is determined that a residual image noise has not occurred. In addition, when the MVy is equal to or larger than the −MVThr, because, regarding the vertical direction, the direction from the upper right adjacent block 503 toward the encoding target block 500 is different from the movement direction of the object, it is determined that a residual image noise has not occurred. As described above, when it is determined that a residual image noise has not occurred in the horizontal and vertical directions, the intra/inter determination step S403 proceeds to the inter mode usage step S105, and the inter mode is used as the encoding mode for the encoding target block (MBType=INTER).

At the third difference absolute value sum comparison step S4013, a difference absolute value between the difference absolute value sum (CurrSAD) for the encoding target block which is calculated at the encoding target block difference absolute value sum calculation step S101 and the difference absolute value sum S2 for the upper adjacent block 502 which is obtained at the adjacent block difference absolute value sum obtaining step S402 is calculated, and compared with the predetermined threshold Thr3. When the difference absolute value is larger than the predetermined threshold Thr3 ((CurrSAD−S2)>Thr3), the intra/inter determination step S403 proceeds to the third motion vector comparison step S4023. In a case other than the above case, it is determined that a residual image noise has not occurred, the intra/inter determination step S403 proceeds to the inter mode usage step S105, and the inter mode is used as the encoding mode for the encoding target block (MBType=INTER).

At the third motion vector comparison step S4023, the vertical component MVy of the motion vector (CurrMV) of the encoding target block is compared with the predetermined motion vector threshold (−MVThr) to determine the movement direction of the object with respect to the encoding target block. When the MVy is smaller than the −MVThr (MVy<−MVThr), the object is considered to move downward. By determining that (CurrSAD−S2)>Thr3 at the third difference absolute value sum comparison step S4013, it is seen that the CurrSAD for the encoding target block has increased from the difference absolute value sum S2 for the upper adjacent block. Thus, when the MVy is smaller than the −MVThr (MVy<−MVThr), it is determined that a residual image noise occurs on an upper side of the object when the object moves downward. In this case, the intra/inter determination step S403 proceeds to the intra mode usage step S104, and the intra mode is used as the encoding mode for the encoding target block (MBType=INTRA).

On the other hand, when the MVy is equal to or larger than the −MVThr, because the CurrSAD for the encoding target block has increased from the difference absolute value sum S2 for the upper adjacent block and a direction from the upper adjacent block 502 toward the encoding target block 500 is different from the movement direction of the object, it is determined that a residual image noise has not occurred. In this case, the intra/inter determination step S403 proceeds to the inter mode usage step S105, and the inter mode is used as the encoding mode for the encoding target block (MBType=INTER).

In the first embodiment of the present invention, the difference absolute values between the difference absolute value sum (CurrSAD) for the encoding target block and the difference absolute value sums S1 and S2 for the blocks adjacent to the encoding target block on the upper and left sides, respectively, are used for the intra/inter determination. In this case, it is effective for a residual image noise which occurs when an object moves rightward or downward. However, because a residual image noise occurs on a right or lower side of the object when an object moves leftward or upward, the intra/inter determination cannot be appropriately made. Here, in the second embodiment of the present invention, positions of adjacent blocks used for the intra/inter determination are changed according to a direction of a motion vector, thereby preventing image degradation due to occurrence of a residual image noise even when an object moves leftward or upward.

Thus, by making the above intra/inter determination, the intra mode is appropriately used only for blocks where a residual image noise occurs even when an object moves in a direction other than rightward or downward.

As described above, according to the intra/inter determination according to the second embodiment of the present invention, in an intra/inter determination in moving image encoding at a low bit rate, positions of adjacent blocks used for the intra/inter determination are changed according to a direction of a motion vector, thereby preventing occurrence of a residual image noise with any movement direction of the object without limiting a movement direction of an object to a constant direction. Thus, the intra/inter determination according to the second embodiment of the present invention can realize a moving image encoding method which prevents image degradation while suppressing an increase in an amount of codes in encoding a moving image more than the intra/inter determination according to the first embodiment of the present invention.

It should be understood that in the present embodiment, the same advantageous effect is obtained even when, as a method of calculating a difference absolute value sum (SAD) for an adjacent block of the encoding target block, the difference absolute value sum storing step S106 and the difference information memory 100 are not included, and the difference absolute value sum (SAD) is calculated based on a reference image and the adjacent block at the adjacent block difference absolute value sum obtaining step S102.

The present embodiment has described the case of using the left adjacent block, the upper adjacent block, and the upper right adjacent block as adjacent blocks, but the present invention is not limited thereto. For example, difference absolute value sums (SADs) for blocks adjacent to the encoding target block on an upper left, right, and lower sides thereof, respectively, may be used. By using blocks adjacent to the encoding target block in all eight directions therefrom and a direction of a motion vector for the intra/inter determination, occurrence of a residual image noise can be prevented even when a movement direction of an object is any direction. In this case, because SADs for blocks adjacent to the encoding target block on right and lower sides thereof, respectively, are also needed, the SADs for the blocks needed to be calculated prior to the intra/inter determination for the encoding target block.

Further, the first and second embodiments of the present invention have described that a threshold to be compared with a difference between difference absolute value sums is a predetermined value, but the present invention is not limited thereto. For example, a threshold may be changed depending on a value of a quantization parameter or a motion vector. When a value of a quantization parameter is small and fine quantization is performed, a residual image noise is eliminated by a difference image even if the inter mode is selected. Thus, there will be no problem if a threshold is made to be large to make it difficult to select the intra mode. For example, a method using a table such that a large threshold is selected when a value of a quantization parameter is small and a small threshold is selected when a value of a quantization parameter is large, and the like is considered. Further, a threshold to be compared with a difference between difference absolute value sums can be calculated using a function.

In addition, because it is considered that when a magnitude of a motion vector is large, a movement distance is large and a residual image noise is likely to occur, a threshold to be compared with a difference between difference absolute value sums can be made to be small to make it easy to select the intra mode. For example, a method using a table such that a threshold to be compared with a difference between difference absolute value sums is made to be large when a magnitude of a motion vector is small and a threshold to be compared with a difference between difference absolute value sums is made to be small when a magnitude of a motion vector is large, and the like is considered. Further, a threshold to be compared with a difference between difference absolute value sums can be calculated using a function.

Further, the first and second embodiments of the present invention has described that the intra/inter determination is made with comparison of differences between the difference absolute value sum (CurrSAD) for the encoding target block and the difference absolute value sums (SADs) for the adjacent blocks, or with a combination of the comparison of the differences and comparison of the motion vector (CurrMV), but the intra/inter determination is not limited thereto. For example, the intra/inter determination according to the first and second embodiments of the present invention may be combined with the conventional intra/inter determination. In the intra/inter determination according to the first and second embodiments of the present invention, the intra mode is used for blocks where a residual image noise occurs, and the inter mode is used for the other blocks. On the other hand, the conventional intra/inter determination is made in consideration of efficiency of encoding. In the intra/inter determination according to the first and second embodiments of the present invention, a case where encoding is more efficient if the intra mode is used for a block for which the inter mode is determined to be used is considered. In this case, the intra mode is used for the block. As described above, by adding the conventional intra/inter determination to the intra/inter determination according to the first and second embodiments of the present invention, efficiency of encoding can be improved.

### Third Embodiment

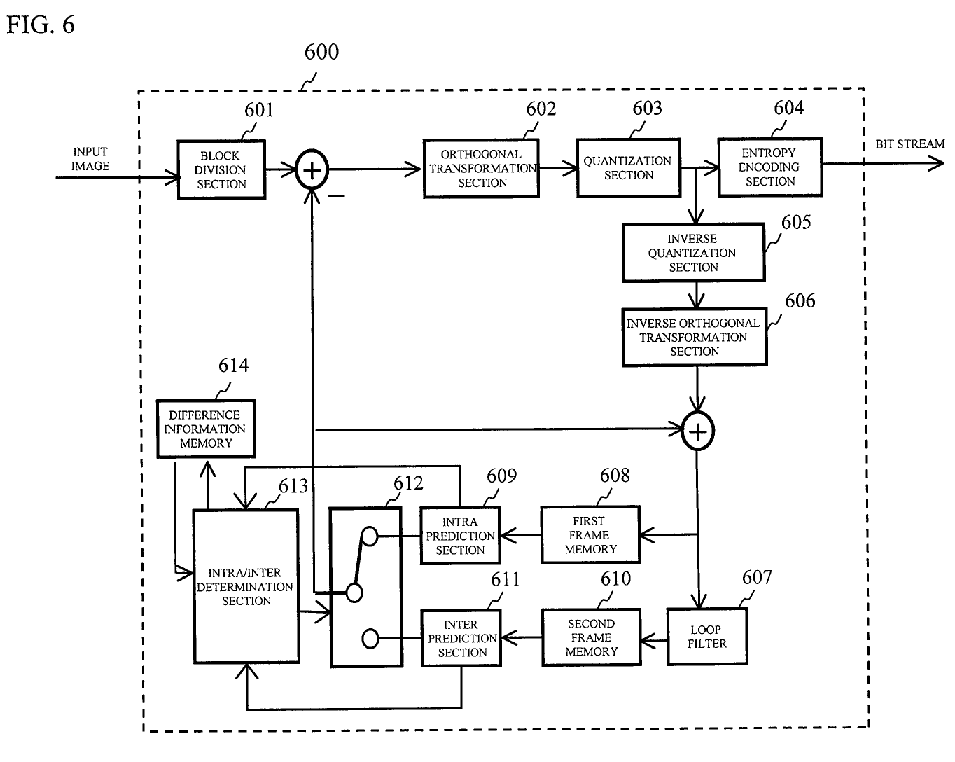

FIG. 6 is a view showing a configuration of an image encoding apparatus 600 according to a third embodiment of the present invention. The image encoding apparatus 600 includes a block division section 601, an orthogonal transformation section 602, a quantization section 603, an entropy encoding section 604, an inverse quantization section 605, an inverse orthogonal transformation section 606, a loop filter 607, a first frame memory 608, an intra prediction section 609, a second frame memory 610, an inter prediction section 611, a selector 612, an intra/inter determination section 613, and a difference information memory 614.

The following will describe image processing in the image encoding apparatus 600. The block division section 601 divides an input image inputted to the image encoding apparatus 600 into blocks. A difference image between one of the blocks of the input image divided by the block division section 601 and a later-described prediction image is orthogonal-transformed by the orthogonal transformation section 602, and quantized by the quantization section 603. A quantization coefficient obtained by the quantization section 603 is encoded by the entropy encoding section 604, and outputted as a bit stream. Further, the quantization coefficient is inverse-quantized by the inverse quantization section 605, and inverse-orthogonal-transformed by the inverse orthogonal transformation section 606.

An image obtained by the inverse orthogonal transformation section 606 is added to the later-described prediction image to generate an image, which is in turn inputted to the first frame memory 608 and the loop filter 607. The image within a frame which is stored in the first frame memory 608 is subjected to intra-frame prediction by the intra prediction section 609, and inputted to the intra/inter determination section 613.

On the other hand, the loop filter 607 performs deblocking filtering on the inputted image within the frame. The image on which deblocking filtering has been performed by the loop filter 607 is stored by the second frame memory 610. Further, the image is subjected to inter-frame prediction by the inter prediction section 611, and inputted to the intra/inter determination section 613. Difference information obtained by the inter prediction section 611 is stored by the difference information memory 614 so as to be used as difference information of adjacent blocks adjacent to process blocks which are to be sequentially processed.

The intra/inter determination section 613 makes an intra/inter determination using activity information obtained by the intra prediction section 609, the difference information obtained by the inter prediction section 611, and difference information of an adjacent block obtained from the difference information memory 614. Here, the intra/inter determination section 613 makes the intra/inter determination by the intra/inter determination method according to the first embodiment or the second embodiment of the present invention.

The selector 612 selects either the prediction image obtained by the intra prediction section 609 or the prediction image obtained by the inter prediction section 611 based on a determination result obtained by the intra/inter determination section 613, and adds a selected prediction image to the input image outputted from the block division section 601 and the image outputted from the inverse orthogonal transformation section 606.

As described above, according to the image encoding apparatus according to the third embodiment of the present invention, in the intra/inter determination section, by using the moving image encoding method described in the first and second embodiments of the present invention, the intra mode is used only for blocks where a residual image noise occurs, thereby realizing an image encoding apparatus which prevents image degradation while suppressing an increase in an amount of codes in encoding a moving image at a low bit rate.

The image encoding apparatus 600 is typically realized as an LSI which is an integrated circuit. Each of the function blocks of the image encoding apparatus 600 may be individually made into one chip, or a part or all of the function blocks may be made into one chip. Although the LSI is described here, the integrated circuit is referred to as an IC, a system LSI, a super LSI, an ultra LSI depending on difference in integration degrees.

A technique of integrated circuit implementation is not limited to the LSI, but may be realized by a dedicated circuit or a universal processor. An FPGA (Field Programmable Gate Array) which is programmable after production of an LSI and a reconfigurable processor in which the connection and the setting of a circuit cell inside the LSI are reconfigurable may be used.

Further, if a technique of integrated circuit implementation which replaces the LSI by advancement of semiconductor technique or another technique derived therefrom is developed, naturally, the function blocks may be integrated by using the technique. Adaptation of a bio technique could be possible.

### Fourth Embodiment

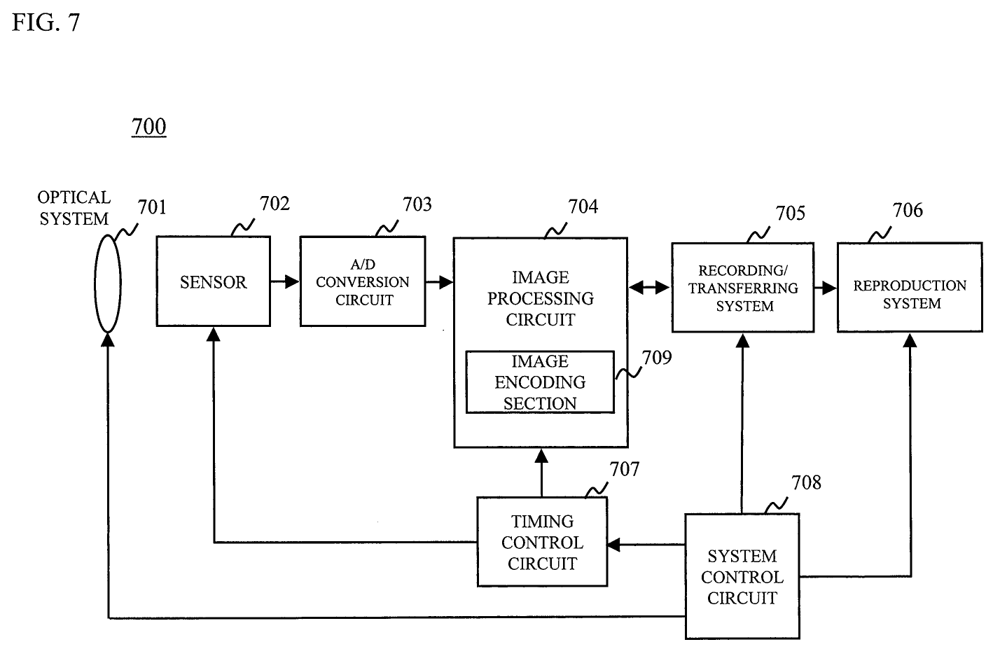

A fourth embodiment of the present invention will describe an example of a photographing system (video system), such as a digital still camera, a network camera, and the like, that uses the moving image encoding method described in the first and second embodiments of the present invention. FIG. 7 is a view showing a configuration of a photographing system 700 according to the fourth embodiment of the present invention. The photographing system 700 includes an optical system 701, a sensor 702, an A/D conversion circuit 703, an image processing circuit 704, a recording/transferring system 705, a reproduction system 706, a timing control circuit 707, and a system control circuit 708.

The following will describe image processing in the photographing system 700. Incident image light which has passed through the optical system 701 is caused to form an image on the sensor 702, and is photoelectric-converted. An electric signal obtained by photoelectric conversion is converted by the A/D conversion circuit 703 into a digital signal, which is in turn inputted to the image processing circuit 704. The image processing circuit 704 includes, for example, an image encoding section 709 for executing the image encoding method described in the first embodiment of the present invention. In the image processing circuit 704, Y/C processing, edge processing, and processing of zooming in or out an image, and the like are performed. In the image processing circuit 704, further, processing of compressing/expanding an image such as a JPEG image, an MPEG image, and the like, control of a stream obtained by compressing an image, and the like are performed. The digital signal which has been image-processed by the image processing circuit 704 is recorded into a medium or transferred via the Internet or the like by the recording/transferring system 705. The digital signal recorded or transferred by the recording/transferring system 705 is reproduced by the reproduction system 706. The sensor 702 and the image processing circuit 704 are controlled by the timing control circuit 707. The optical system 701, the recording/transferring system 705, the reproduction system 706, and the timing control circuit 707 are controlled by the system control circuit 708.

As described above, according to the photographing system according to the fourth embodiment of the present invention, the moving image encoding method described in the first and the second embodiments of the present invention is used in the image processing circuit. Thus, an intra mode is used only for blocks where a residual image noise occurs, thereby realizing a photographing system which prevents image degradation while suppressing an increase in an amount of codes in encoding a moving image at a low bit rate.

The photographing system 700, shown in FIG. 7, including a camera device, and the like in which image light from the optical system 701 is photoelectric-converted by the sensor 702 and inputted to the A/D conversion circuit 703 has been described. However, a photographing system according to the present invention is not limited thereto. It should be understood that alternatively, an analog video input of AV equipment such as a television, and the like may be inputted to the A/D conversion circuit 703.

While the invention has been described in detail, the foregoing description is in all aspects illustrative and not restrictive. It is understood that numerous other modifications and variations can be devised without departing from the scope of the invention.

What is claimed is:

1. An image encoding method for adaptively selecting either an intra mode which is intra-frame encoding or an inter mode which is inter-frame encoding and for sequentially encoding a predetermined block image, the image encoding method comprising:
an encoding target block difference information calculation step of calculating first difference information based on an encoding target block and a reference image;
an adjacent block difference information calculation step of calculating at least one or more pieces of second difference information based on the reference image and at least one or more adjacent blocks among eight adjacent blocks adjacent to the encoding target block;
an intra/inter determination step of calculating at least one or more differences between the first difference information and the second difference information, and comparing said at least one or more differences with a predetermined threshold; and
an intra/inter mode usage step of using either the intra mode or the inter mode as an encoding mode for the encoding target block based on a comparison result of the intra/inter determination step.

2. The image encoding method according to claim 1, wherein,
at the intra/inter mode usage step,
when any of said at least one or more differences is larger than the predetermined threshold, the intra mode is used as the encoding mode for the encoding target block, and
when all of said at least one or more differences are smaller than the predetermined threshold, the inter mode is used as the encoding mode for the encoding target block.

3. The image encoding method according to claim 2, further comprising a difference information storing step of storing the first difference information in a memory, wherein,
at the adjacent block difference information calculation step, when anyone of said eight adjacent blocks becomes an encoding target block, the first difference information stored in the memory is used as the second difference information.

4. The image encoding method according to claim 2, wherein,
the first difference information is a difference absolute value sum between the encoding target block and the reference image,
the second difference information is difference absolute value sums between said at least one or more adjacent blocks and the reference image.

5. The image encoding method according to claim 2, wherein said at least one or more adjacent blocks include a left adjacent block adjacent to the encoding target block on a left side thereof and an upper adjacent block adjacent to the encoding target block on an upper side thereof.

6. The image encoding method according to claim 1, further comprising an activity information determination step of, when all of said at least one or more differences are smaller than the predetermined threshold, calculating activity information indicative of a complexity of the encoding target block, and comparing the activity information with the first difference information, wherein,
at the intra/inter mode usage step,
when any of said at least one or more differences is larger than the predetermined threshold, or when all of said at least one or more differences are smaller than the predetermined threshold and the activity information is smaller than the first difference information, the intra mode is used as the encoding mode for the encoding target block, and
when all of said at least one or more differences are smaller than the predetermined threshold and the activity information is larger than the first difference information, the inter mode is used as the encoding mode for the encoding target block.

7. The image encoding method according to claim 6, wherein,
the activity information is calculated based on a dispersion of the encoding target block, and
the first difference information is calculated based on a dispersion of a difference image between the encoding target block and the reference image.

8. The image encoding method according to claim 1, further comprising an encoding target block motion vector calculation step of calculating a motion vector of the encoding target block, wherein
at the intra/inter mode usage step,
when a residual image noise occurrence condition is satisfied that any of said at least one or more differences is larger than the predetermined threshold, that a magnitude of the motion vector is larger than a predetermined motion vector threshold, and that a direction of the motion vector is a direction from the adjacent block corresponding to said any of said at least one or more differences toward the encoding target block, the intra mode is used as the encoding mode for the encoding target block, and
in a case other than a case where the residual image noise occurrence condition is satisfied, the inter mode is used as the encoding mode for the encoding target block.

9. The image encoding method according to claim 8, further comprising a difference information storing step of storing the first difference information in a memory, wherein,
at the adjacent block difference information calculation step, when anyone of said eight adjacent blocks becomes an encoding target block, the first difference information stored in the memory is used as the second difference information.

10. The image encoding method according to claim 8, wherein the predetermined threshold is adaptively changed based on a magnitude of a quantization parameter.

11. The image encoding method according to claim 8, wherein the predetermined threshold is adaptively changed based on a magnitude of the motion vector.

12. An image encoding apparatus for adaptively selecting either an intra mode which is intra-frame encoding or an inter mode which is inter-frame encoding and for sequentially encoding a predetermined block image, the image encoding apparatus comprising:
an encoding target block difference information calculation section for calculating first difference information based on an encoding target block and a reference image;
an adjacent block difference information calculation section for calculating at least one or more pieces of second difference information based on the reference image and at least one or more adjacent blocks among eight adjacent blocks adjacent to the encoding target block;
an intra/inter determination section for calculating at least one or more differences between the first difference information and the second difference information, and comparing said at least one or more differences with a predetermined threshold;
an intra mode usage section for using the intra mode as an encoding mode for the encoding target block when any of said at least one or more differences is larger than the predetermined threshold; and
an inter mode usage section for using the inter mode as the encoding mode for the encoding target block when all of said at least one or more differences are smaller than the predetermined threshold.

13. The image encoding apparatus according to claim 12, further comprising a difference information storing section for storing the first difference information in a memory, wherein,
the adjacent block difference information calculation section uses the first difference information stored in the memory as the second difference information when any one of said eight adjacent blocks becomes an encoding target block.

14. The image encoding apparatus according to claim 12, wherein,
the first difference information is a difference absolute value sum between the encoding target block and the reference image, and
the second difference information is difference absolute value sums between said at least one or more adjacent blocks and the reference image.

15. The image encoding apparatus according to claim 12, wherein said at least one or more adjacent blocks include a left adjacent block adjacent to the encoding target block on a left side thereof and an upper adjacent block adjacent to the encoding target block on an upper side thereof.

16. The image encoding apparatus according to claim 12, wherein the predetermined threshold is adaptively changed based on a magnitude of a quantization parameter.

17. An integrated circuit for use in an image encoding apparatus for adaptively selecting either an intra mode which is intra-frame encoding and an inter mode which is inter-frame encoding and for sequentially encoding a predetermined block image, the integrated circuit functioning as:
an encoding target block difference information calculation section of calculating first difference information based on an encoding target block and a reference image;
an adjacent block difference information calculation section of calculating at least one or more pieces of second difference information based on the reference image and at least one or more adjacent blocks among eight adjacent blocks adjacent to the encoding target block;
an intra/inter determination section of calculating at least one or more differences between the first difference information and the second difference information, and comparing said at least one or more differences with a predetermined threshold;
an intra mode usage section of using the intra mode as an encoding mode for the encoding target block when any of said at least one or more differences is larger than the predetermined threshold; and
an inter mode usage section of using the inter mode as the encoding mode for the encoding target block when all of said at least one or more differences are smaller than the predetermined threshold.

18. A photographing system for using an image encoding method in which either an intra mode which is intra-frame encoding and an inter mode which is inter-frame encoding is adaptively selected and a predetermined block image is sequentially encoded, the photographing system comprising:
an optical system for causing incident image light to form an image;
a sensor for converting the image light which is caused to form the image into an image signal; and
an image processing circuit for imaging-processing the image signal, wherein
the image processing circuit executes an image encoding method comprising:
an encoding target block difference information calculation step of calculating first difference information based on an encoding target block and a reference image;
an adjacent block difference information calculation step of calculating at least one or more pieces of second difference information based on the reference image and at least one or more adjacent blocks among eight adjacent blocks adjacent to the encoding target block;
an intra/inter determination step of calculating at least one or more differences between the first difference information and the second difference information, and comparing said at least one or more differences with a predetermined threshold;
an intra mode usage step of using the intra mode as an encoding mode for the encoding target block when any of said at least one or more differences is larger than the predetermined threshold; and
an inter mode usage step of using the inter mode as the encoding mode for the encoding target block when all of said at least one or more differences are smaller than the predetermined threshold.
